(19) United States
(12) Patent Application Publication
(10) Pub. No.: US 2010/0057547 A1
(43) Pub. Date: Mar. 4, 2010

(54) MARKETING DEVICE FOR A BAG

(75) Inventor: Steven Lynn Nuchols, Torrance, CA (US)

Correspondence Address: DISNEY ENTERPRISES, INC.;C/O CANTOR COLBURN LLP, 20 Church Street, 22nd Floor, Hartford, CT, 06103, US

(73) Assignee: DISNEY ENTERPRISES, INC., Burbank, CA (US)

(21) Appl. No.: 12/202,520

(22) Filed: Sep. 2, 2008

(51) Int. Cl. G06Q 30/00

(52) U.S. Cl. 705/14.4

(57) ABSTRACT

Disclosed is marketing device for a bag, the device including a device body, at least one marketing message disposed on at least one surface of the device body; and an association portion structured to associate the device body with a portion of the bag in proximity to an opening of the bag, wherein the association portion is also structured to associate the device body such that the at least one marketing message is visible to a surrounding environment of the bag in at least one direction.

### FIELD OF THE INVENTION

The disclosure relates generally to a marketing device, and more particularly to a marketing device for a bag.

### BACKGROUND

Promotional/marketing materials can often be difficult to distribute in retail situations. Currently, such materials (i.e. printed articles including event information) are usually distributed at a register of a retail environment, with the materials either being handed to a consumer or placed into a consumer's bag. These methods of distribution do have drawbacks however.

For example, when a consumer is simply handed promotional material, that consumer is inconvenienced in that he or she must now figure out a means for carrying this material. Regardless of how easy it may be simply hold this material, or even put it in one's pocket or purse, it is often easier for the consumer to simply refuse or discard the material. In a busy retail environment, where one might already be carrying many items (bags, kids, food, etc.), the consumer will often choose the easy refusal or discard over anything else.

Placement of promotional material in a consumer's bag upon checkout solves the consumer's issue of how to carry the material, but does not guarantee that the consumer will ever view the material for any significant portion of time. In fact, material placed in a bag at checkout will often be discarded with the bag following removal of the purchased item. In such cases, the material will not be viewed by the consumer for any marketably significant portion of time.

Accordingly, greater assurance that distributed promotional material will leave a retail environment with the consumer, and be viewed as often as possible, would be desirable.

### SUMMARY

Disclosed is a marketing device for a bag, the device including a device body, at least one marketing message disposed on at least one surface of the device body; and an association portion structured to associate the device body with a portion of the bag in proximity to an opening of the bag, wherein the association portion is also structured to associate the device body such that the at least one marketing message is visible to a surrounding environment of the bag in at least one direction.

Disclosed is bag detachable marketing device system, the system including a bag, a marketing device, at least one marketing message disposed on at least one surface of the marketing device; and an association portion of the marketing device, the association portion detachably associating the marketing device with a portion of the bag in proximity to an opening of the bag, wherein the association portion associates the marketing device with the bag such that the at least one marketing message is visible to a surrounding environment of the bag in at least one direction.

Disclosed is a marketing method including detachably associating a marketing device with a portion of a bag in proximity to an opening of the bag, and positioning the marketing device via the associating such that at least one marketing message disposed on at least one surface of the marketing device is visible to a surrounding environment of the bag in at least one direction.

### BRIEF DESCRIPTION OF THE FIGURES

The foregoing and other features and advantages of the present invention should be more fully understood from the following detailed description of illustrative embodiments taken in conjuncture with the accompanying Figures in which like elements are numbered alike in the several Figures:

FIG. 1 is a side perspective view of a marketing device in association with a bag;

FIG. 2 is a cross-sectional side elevation view of an embodiment of the marketing device in association with a bag;

FIG. 3 is a cross-sectional side elevation view of another embodiment of the marketing device in association with a bag;

FIG. 4 is a rear elevation view of another embodiment of the marketing device in association with a bag, the bag being shown in a cross-sectional view; and

FIG. 5 is a side perspective view of a three-dimensional marketing device in association with the bag of FIG. 1.

### DETAILED DESCRIPTION

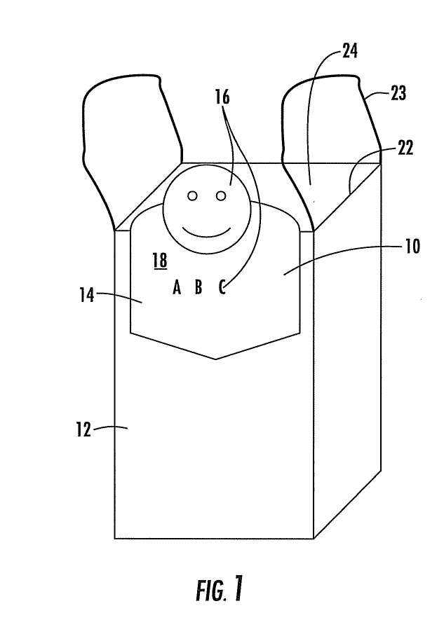

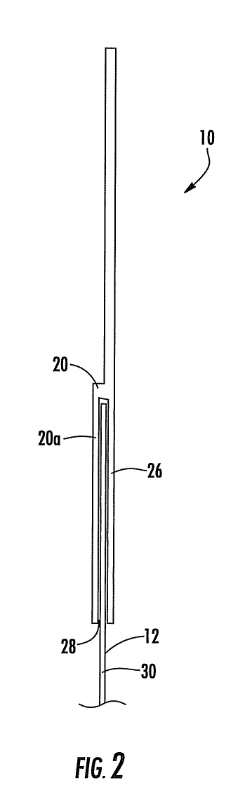

Referring first to FIG. 1, a marketing device 10 is shown in association with a bag 12. The device 10 and bag 12 may be constructed from paper, cardboard, plastic or any other material conducive to the usage discussed herein below. The device 10 includes a device body 14, at least one marketing message 16 disposed at least one a first surface 18 of the device body 14, and an association portion 20 (which is best shown in the embodiments of FIGS. 2-4). The marketing message 16 may be any print/artwork disposed on the surface 18 of the device body 14, or any shaped image formed by a perimeter of the device body 14.

As is shown in FIG. 1, when the device 10 is associated with the bag 12, the marketing message 16 is positioned such that the message 16 is visible (in at least one direction) to consumers in the environment surrounding the bag 12. As is also shown in FIG. 1, the device 10 associates with a relatively upper extent 22 of the bag 12 (the upper extent 22 being inclusive of any bag handles 23), in proximity to an opening 24 of the bag. It should be noted that this association may be a detachable association, wherein the term “detachable” will define the association as one wherein neither the bag 12 nor device 10 would be appreciably destroyed by any detachment of the device 10 from the bag 14.

Referring now to FIGS. 2-4, examples of detachable association portions 20 are illustrated. Starting with FIG. 2, the detachable association portion 20 is illustrated as a forked portion 20a formed at a relatively lower extent 26 of the device body 14. The forked portion 20a defines a clipping cavity 28 that is structured to associate the device 10 with the upper extent 22 of a side 30 of the bag 12. As shown in FIG. 2, this detachable association is formed via a frictional fit between interior surfaces of the clipping cavity 28 and surfaces of the side 30 of the bag 12. As is also shown in FIG. 2 the forked portion 20a may be of unitary construction with a remainder of the device body 14.

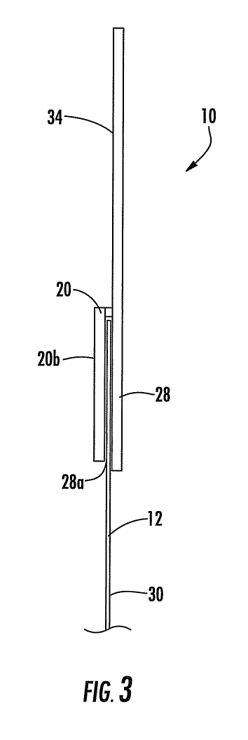

Referring next to FIG. 3, the detachable association portion 20 is illustrated as at least one flange 20b extending from a back surface 34 (facing an interior of the bag 12) of the relatively lower extent 26 of the device body 14. The flange 20b defines a clipping cavity 28a that, similarly to cavity 28, is structured to associate the device 10 with the upper extent 22 of the side 30 of the bag 12. Like that which is shown in FIG. 2, the detachable association of FIG. 3 is formed via a frictional fit between interior surfaces of the clipping cavity 28a and surfaces of the side 30 of the bag 12. As is shown in FIG. 3 the flange 20b may be attached to the remainder of the device body 14 via any mechanical or adhesive means, and may be of the same or different material than the remainder of the device body 14.

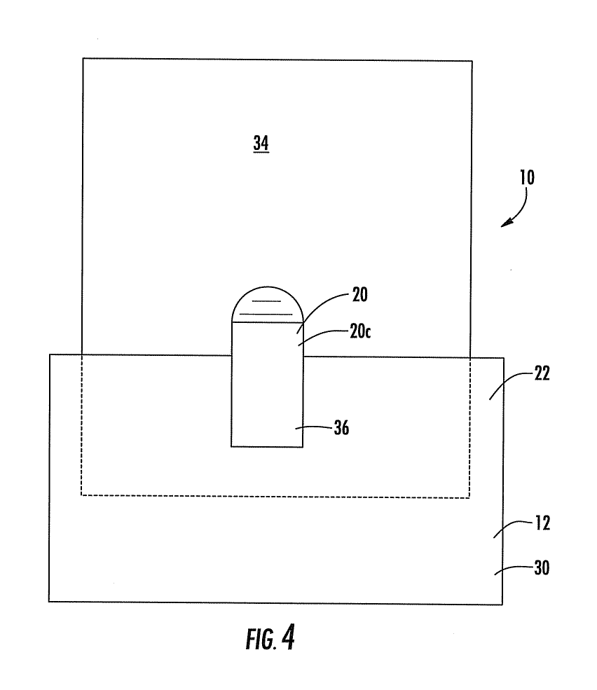

Referring next to FIG. 4, the detachable association portion 20 is illustrated as at least one clipping 20c attached to the back surface 34 of the device body 14. The clipping device 20c may be of any known mechanical design, such as but not limited to a spring-loaded device, wherein clipping portions 36 of the clipping device 20c are biased towards each other so as to grip the upper extent 22 of the side 30 of the bag 12. Of course, this bias is includes a force small enough to be overcome by a typical user (so as to allow attachment/detachment of the clipping device 20c to or from the bag 12). The clipping device 20c may be attached to the remainder of the device body 14 via any mechanical or adhesive means.

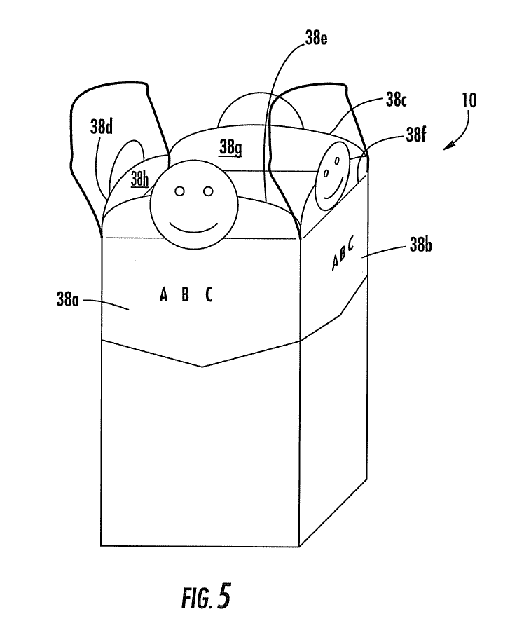

While FIGS. 2-4 show exemplary embodiments of association portions 20, it should be appreciated that the device 10 may be associated with the bag via any association portion conducive to securing the device 10 to the bag. These portions 20 may additionally include, but are limited to, a snapping feature, tie feature, or Velcro feature, which may each include varying degrees of detachability or non-detachability. Furthermore, while the embodiments of FIGS. 1-4 show a substantially two-dimensional device 10 that includes the marketing message 16 on the first surface 18 only, it should be appreciated that the marketing message 16 may additionally be disposed on a second or back surface 34, and the same or different from the message 16 disposed on the first surface 18. Still further, as shown in FIG. 5, the device 10 may be substantially three-dimensional (FIG. 5 simply illustrating four attached two-dimensional devices 10), and include three to eight surfaces (FIG. 5 illustrating eight surfaces 38a-h) which each may include the same or different instances of the marketing message(s) 16.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. A marketing device for a bag, the device comprising:
a device body;
at least one marketing message disposed on at least one surface of said device body; and
an association portion structured to associate said device body with a portion of the bag in proximity to an opening of the bag, wherein said association portion is also structured to associate said device body such that said at least one marketing message is visible to a surrounding environment of the bag in at least one direction.

2. The device of claim 1, wherein said association portion is a clipping cavity defined by said device body, said clipping cavity being structured to associate said device body with a relatively upper extent of a side of the bag via a frictional fit between interior surfaces of said clipping cavity and the relatively upper extent of the side of the bag.

3. The device of claim 1, wherein said association portion is at least one a flange forming cavity or clipping device structured to associates said device body with at least one of a relative top portion of the bag and a handle extending from the bag.

4. The device of claim 1, wherein said device body is a substantially two-dimensional body that is structured to associate with a relative top portion of one side of the bag.

5. The device of claim 4, wherein said substantially two-dimensional body includes a first surface and a second surface, said at least one marketing message being disposed on at least one of said first surface and said second surface.

6. The device of claim 5, wherein said marketing message is disposed on both of said first surface and said second surface, and wherein said at least one marketing message is a first marketing message and a second marketing message, said first marketing message being different from said second marketing message, said first surface including said first marketing message and said second surface including said second marketing message.

7. The device of claim 1, wherein said device body is a substantially three-dimensional body that is structured to associate with a relative top portion of one side of the bag.

8. The device of claim 7, wherein said substantially three-dimensional body includes at least three surfaces, said at least one marketing message being disposed on each of said at least three surfaces.

9. The device of claim 8, wherein said at least one marketing message is at least three marketing messages, at least two of said at least three marketing messages being different from each other, and at least two of said at least three surfaces including different marketing massages.

10. The device of claim 1, wherein said device body is detachably associable with the bag via said association portion.

11. The device of claim 1, wherein said device body is shaped in the form of a image to be marketed.

12. A bag detachable marketing device system, the system comprising:
a bag
a marketing device;
at least one marketing message disposed on at least one surface of said marketing device; and
an association portion of said marketing device, said association portion detachably associating said marketing device with a portion of said bag in proximity to an opening of said bag, wherein said association portion associates said marketing device with said bag such that said at least one marketing message is visible to a surrounding environment of said bag in at least one direction.

13. A marketing method comprising:
detachably associating a marketing device with a portion of a bag in proximity to an opening of said bag; and
positioning said marketing device via said associating such that at least one marketing message disposed on at least one surface of said marketing device is visible to a surrounding environment of said bag in at least one direction.
